(19) United States
(12) Patent Application Publication
(10) Pub. No.: US 2013/0134716 A1
(43) Pub. Date: May 30, 2013

(54) ET Power System

(71) Applicant: Minh T. Tran, Wichita, KS (US)

(72) Inventor: Minh T. Tran, Wichita, KS (US)

(21) Appl. No.: 13/072,100

(22) Filed: Nov. 28, 2011

(51) Int. Cl. F03D 9/00; H02N 11/00

(52) U.S. Cl. 290/55

(57) ABSTRACT

ET Power system is a system that can run forever without stopping and it also provide electricity for any electronic device and household items that run on electricity. By a quick rotation of magnets to create electricity and keep rotating until it force to stop. In another words, this is the system that can provide electricity for lifetime without consuming anything.

### FIELD OF INVENTION

This invention is related to clean energy and manufacture industry such that no more cars will run on gas which increasing the carbon dioxide in the atmosphere and causing global warming. With this invention the gas on car problem will be solve and also reduce the global warming.

### BACKGROUND

Today, people desperate for gas and they will pay anything to buy gas because without gas, they cannot go anywhere even go to work or enjoy on a vacation. There is no solution of clean energy that has enough power to reduce the consuming of gas which produce carbon dioxide into the air and cause more global warming every day. This ET Power System will solve this solution as it can provide the car with the electric power and does not exhaust anything which will make the clear environment and reduce global warming.

### SUMMARY OF INVENTION

ET Power System is a connect of many part to create a system that can run for ever without stopping and consuming any other materials. They use the wind generator to create electricity. This source of electricity will divide into two parts. One is to the motor which will provide wind to the wind generator and create a full circle and keep the system running. Meanwhile, the other electricity go through a transformer and turn into an outlet for any machine or household that consume electricity.

### DESCRIPTION OF DRAWING

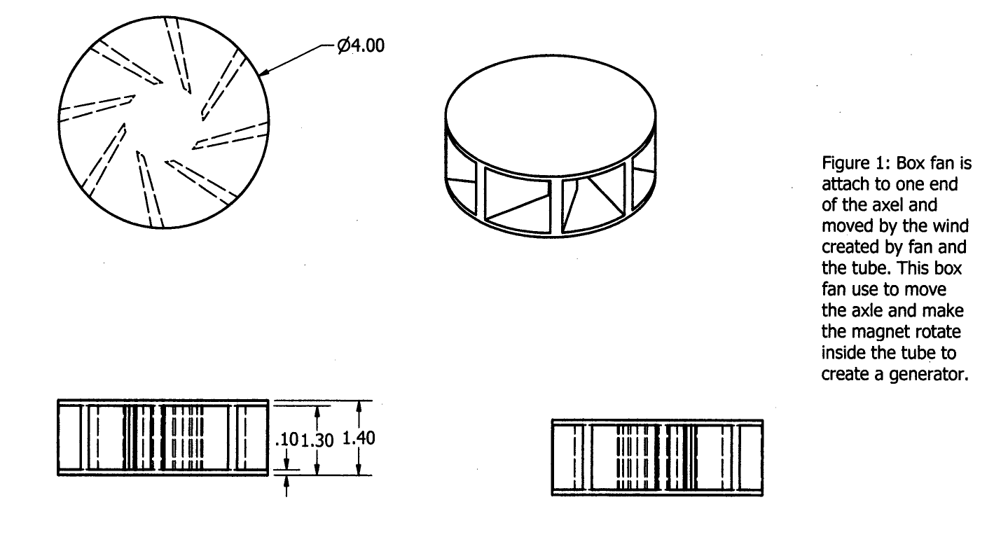

1. FIG. 1: Box fan is attach to one end of the axel and moved by the wind created by fan and the tube. This box fan use to move the axle and make the magnet rotate inside the tube to create a generator.

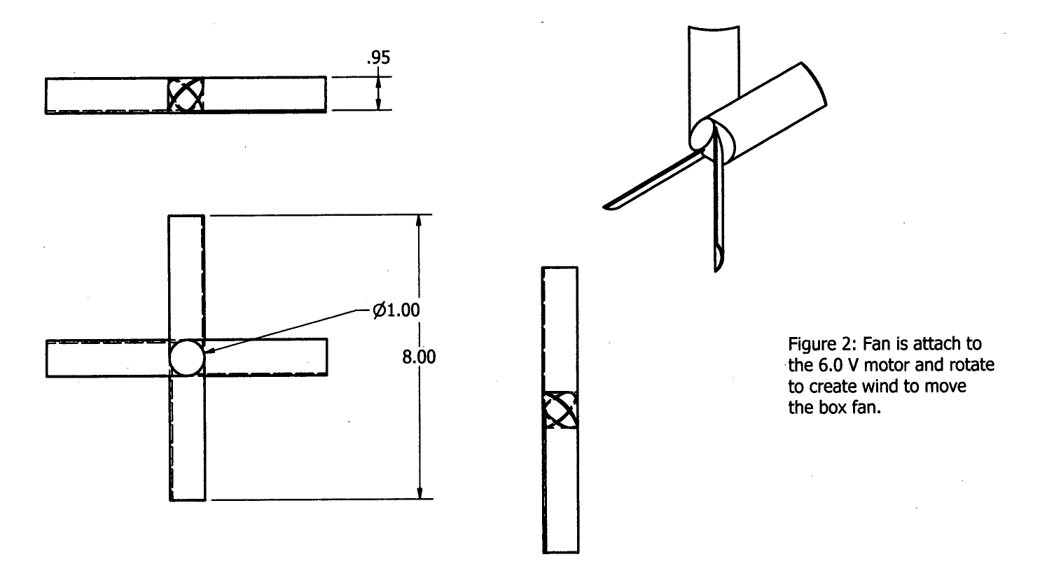

2. FIG. 2: Fan is attach to the 6.0 V motor and rotate to create wind to move through the tube and to the box fan.

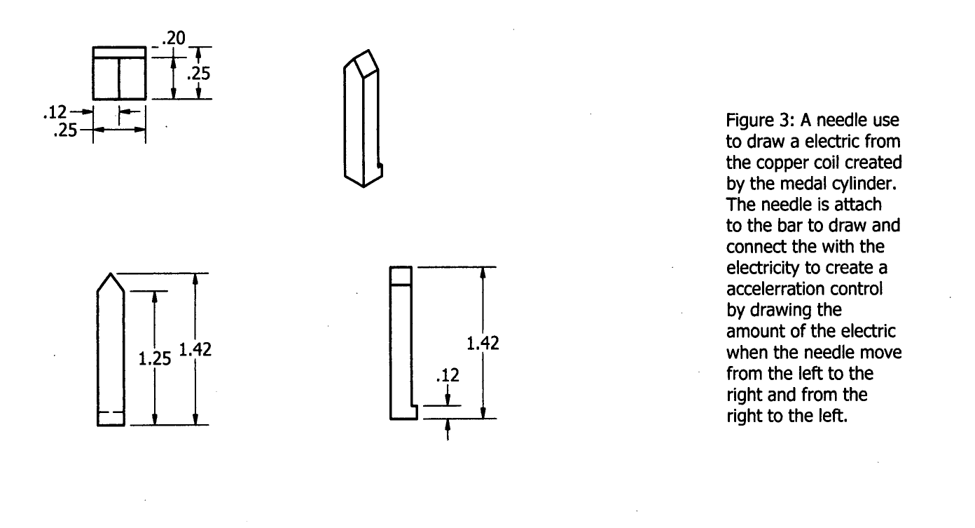

3. FIG. 3: A needle use to draw an electric from the copper coil created by the medal cylinder. The needle is attach to the bar to draw the electricity to create an acceleration control by drawing the amount of the electric when the needle move from the left to the right and from the right to the left.

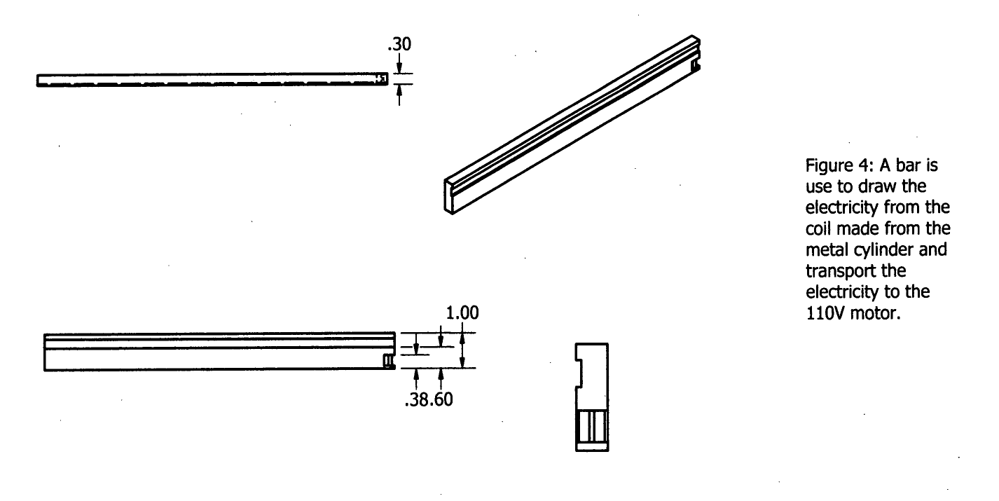

4. FIG. 4: A bar is use to draw the electricity from the coil made from the metal cylinder and transport the electricity to the 110V motor.

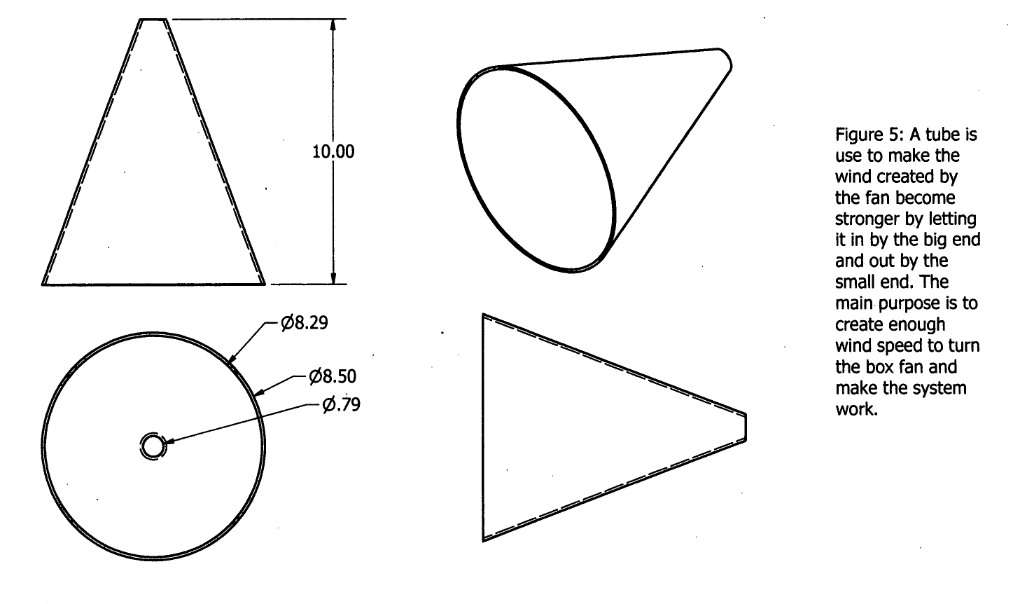

5. FIG. 5: A tube is use to make the wind created by the fan become stronger by letting it in with the big end and out by the small end. The main purpose is to create enough wind speed to turn the box fan and make the system work.

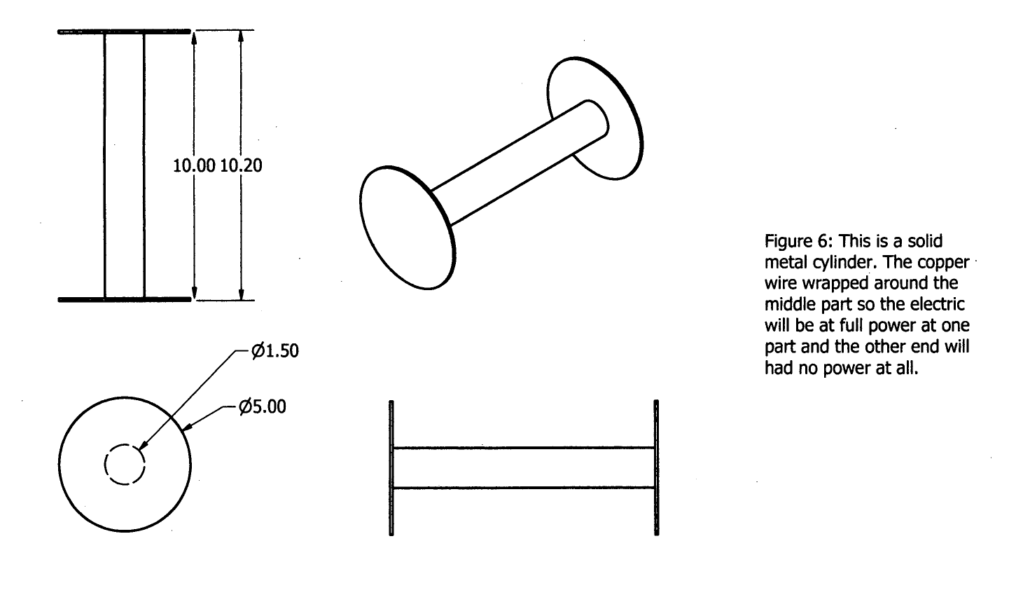

6. FIG. 6: A solid metal cylinder is the cylinder with copper wire wrapped around the middle part so the electric will be at full power at one part and the other end will have no power.

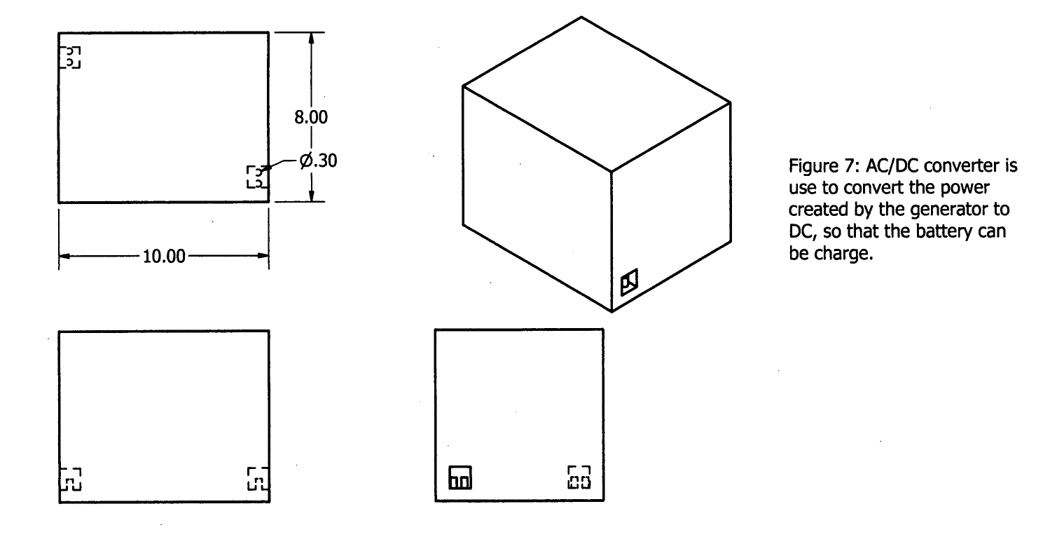

7. FIG. 7: AC/DC converter: use to convert the power created by the generator to DC, so that the battery can be charge.

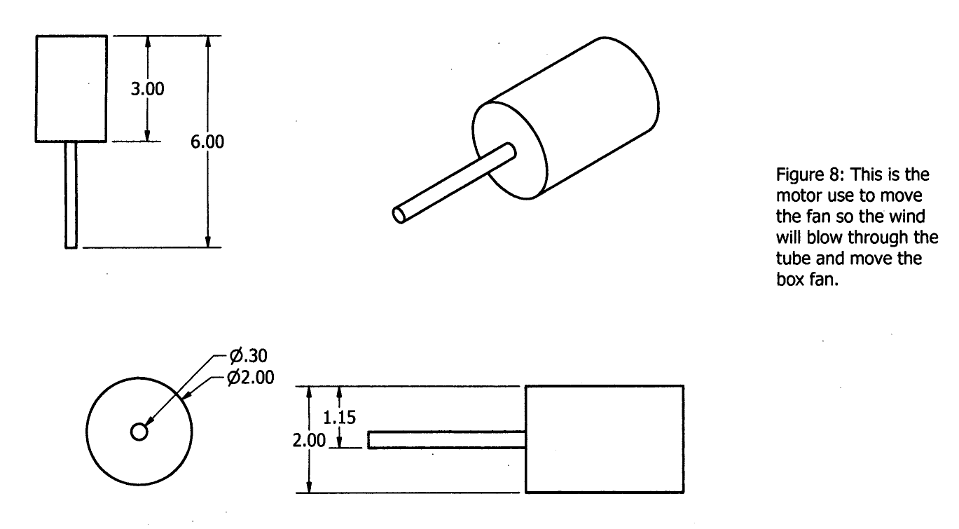

8. FIG. 8: 6.0 V motor is the motor use to move the fan so the wind will blow through the tube and move the box fan.

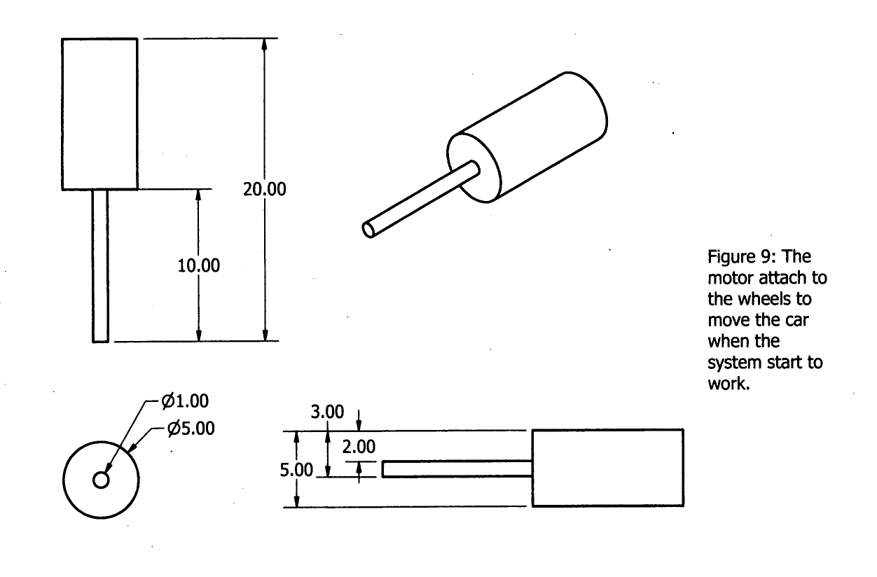

9. FIG. 9: 110 V motor is the motor attach to the wheels to move the car when the system start to work.

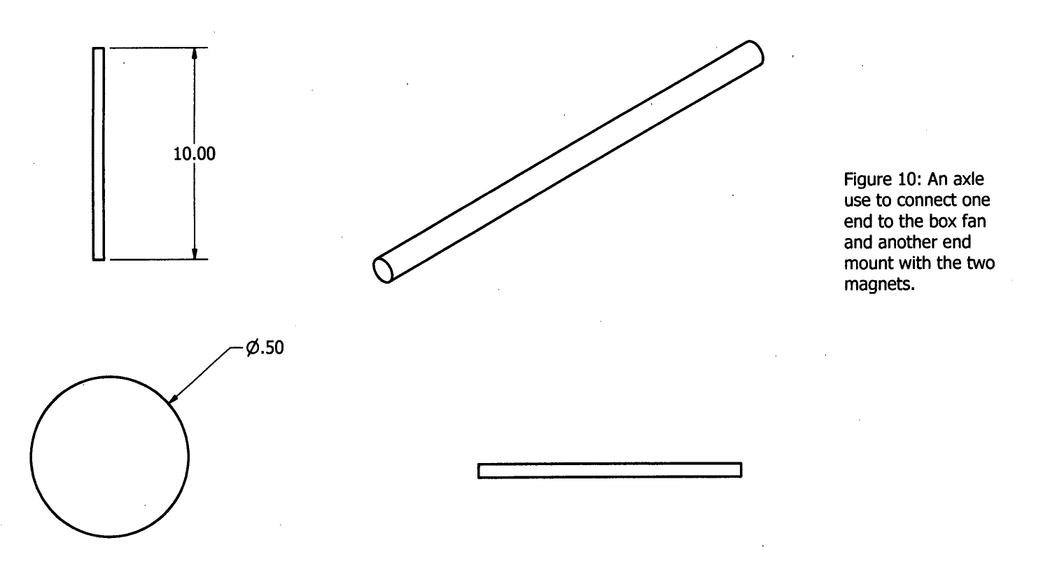

10. FIG. 10: An axle use to connect one end to the box fan and another end mount with the two magnets.

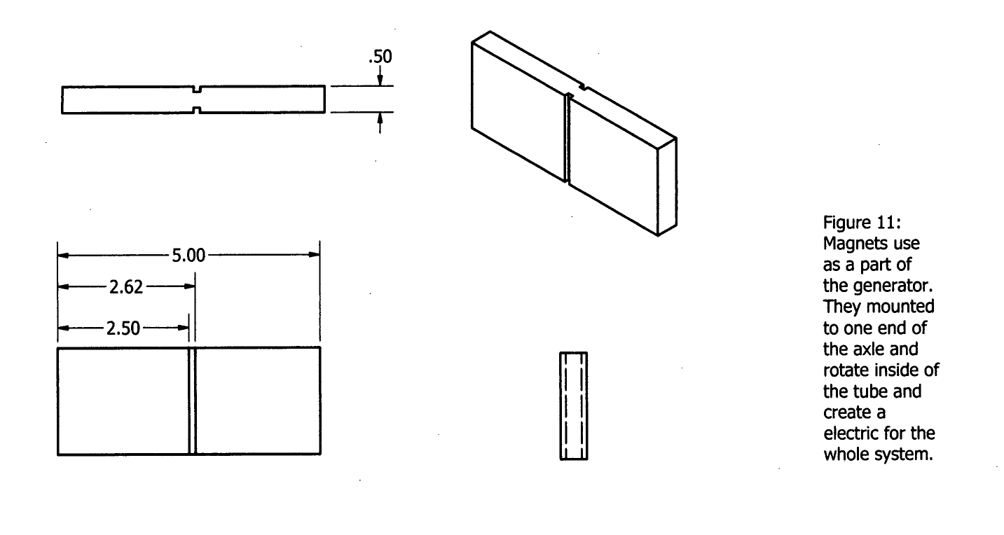

11. FIG. 11: Magnets use as a part of the generator. They mounted to one end of the axle and rotate inside of the tube and create an electric for the whole system.

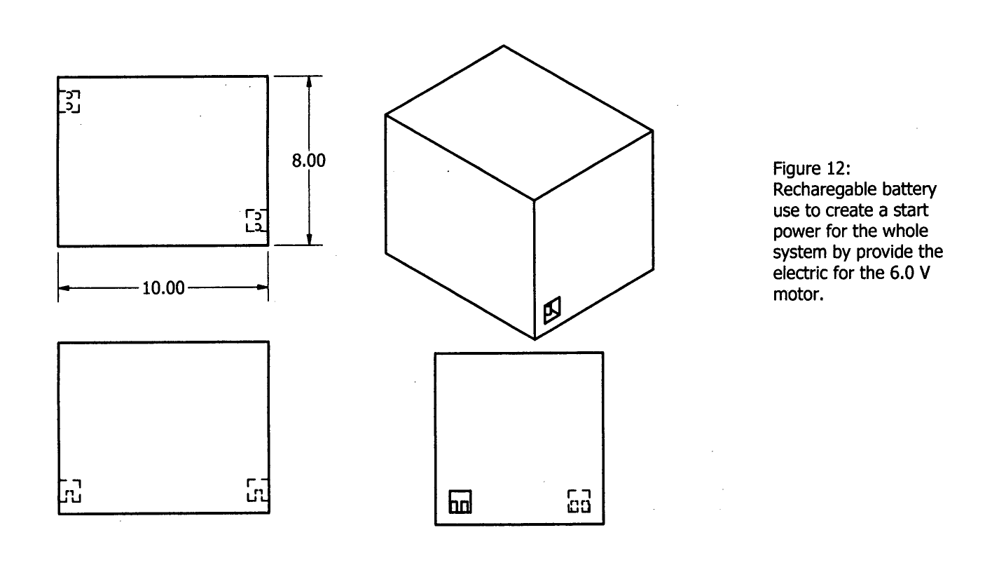

12. FIG. 12: Rechargeable battery use to create a start power for the whole system by provides the electric for the 6.0 V motor.

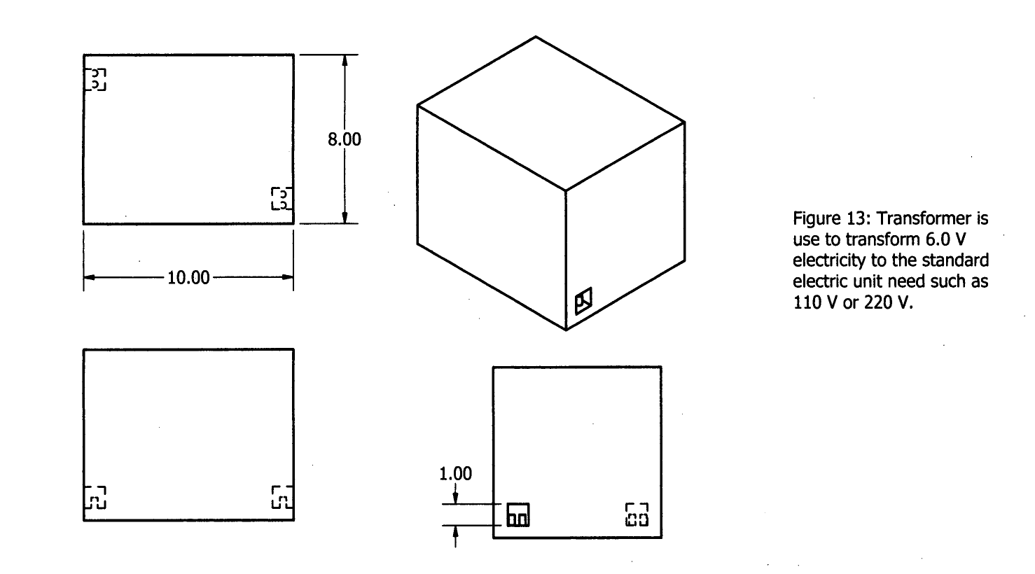

13. FIG. 13: Transformer is use to transform 6.0 V electricity to the standard electric unit need such as 110 V or 220 V.

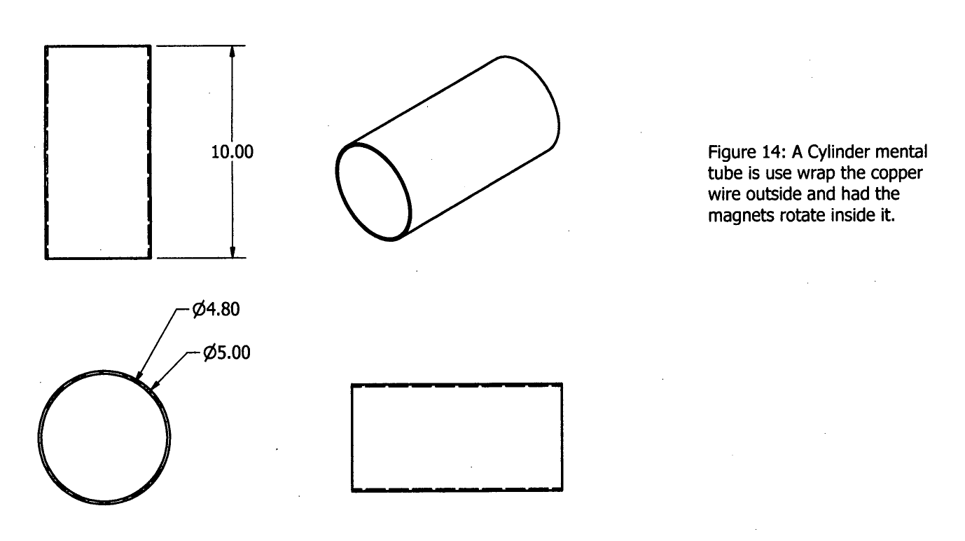

14. FIG. 14: A Cylinder mental tube is use wrap the copper wire outside and had the magnets rotate inside it.

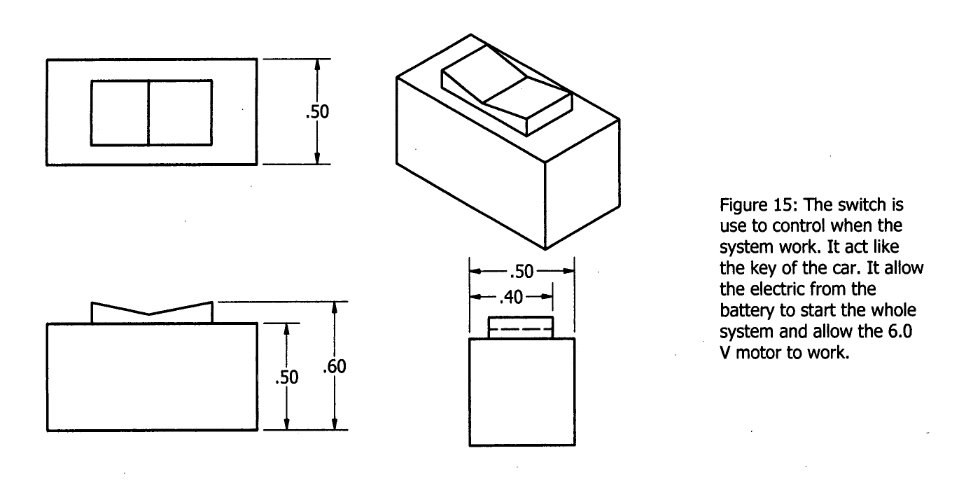

15. FIG. 15: The switch is use to control when the system work. It acts like the key of the car. It allows the electric from the battery to start the whole system and allow the 6.0 V motor to work.

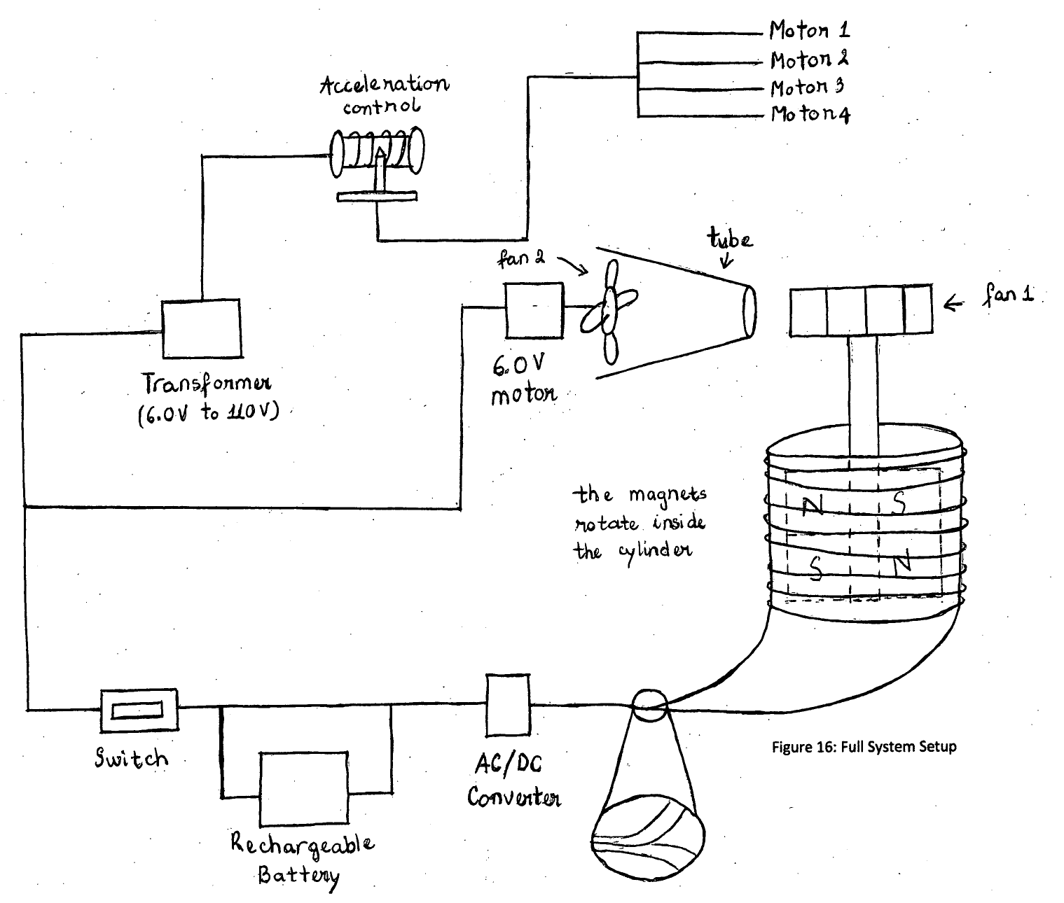

16. FIG. 16: The diagram to assemble all the part in the ET Power System.

### HOW IT WORKS

The first thing to know is to create a generator from the parts by mounting the magnets to the end of the axle and the box fan to another end of the axle. Then wrap the copper wires around the cylinder tube and put the magnet inside the tube. When the magnet rotate, the electric will create from the change of magnetic field effect on the coil wrap around outside of the cylinder.

Second is to let the electric flow through the AC/DC converter. Then the electric will go through the rechargeable battery. The battery is to be parallel with the wire (as shown in the diagram). After the battery will be the switch. This switch control all by enable and disable any electricity from the generator and the battery to the system.

After the switch the electric will be dividing again by parallel process. The first branch of electric will go to the 6.0 V motor. This motor is providing power to move the fan and blow wind into the tube. The tube will increase the wind by using its shape and blow the wind to create movement for box fan which will also make the magnet inside the cylinder to rotate (the generator has mention above). When the generator created electricity, it will be use to keep the system going and charging the battery at the same time.

On the other ranch of the electric after separate from the switch, the electricity will go to the transformer which transfer from 6.0 V to what voltage is necessary (it's 110 V in my case). After the electric had been transform into a stronger source then it'll go through the acceleration control. Acceleration control is created by wrapping the electric wires around the solid metal cylinder to create a thick coil has a great restriction on electricity. The electric will go in at one end and will be totally disappear will moving along the coil. There will be a needle which already attach to the bar and can move along the bar. When this needle at the end where the electric come into the coil, then the needle will get the full power of electric which is 110 V and pass to the bar. Otherwise, the needle go to the far end of the coil and receive no electric at all because the electric already dispose by the coil. The final thing is that after go through the acceleration control the electric will be connecting with the 110 V motor which will move the car.

Note: This is the system that can keep running forever. This system can run without any other source and provide electricity for any electric machine or any household item such as refrigerators, TVs, stoves, or any electric households. I draw the system on the car because this is the full system. It is different because it need (must have) the acceleration control and the 110V motor. For any other electric device that needs the constant electricity, the acceleration control is not necessary. For the car, one or more generator may needed to provide enough electricity.

1. With the wind power created by a fan and go through a tube to create stronger winds, the box fan can move and create an ongoing electric system that can run forever without any help from consuming gas or any other materials which is also create another source of electric that can run for any house hold items that consume electricity and create enough electric to run a car.
